(19) United States
(12) Patent Application Publication
(10) Pub. No.: US 2015/0019852 A1
(43) Pub. Date: Jan. 15, 2015

(54) VERIFICATION METHOD FOR SYSTEM EXECUTION ENVIRONMENT

(71) Applicant: INTERNATIONAL GAMES SYSTEM CO., LTD., New Taipei City (TW)

(72) Inventors: CHIEN-CHIH LIN, NEW TAIPEI CITY (TW); HSIN-YI LAI, NEW TAIPEI CITY (TW)

(73) Assignee: INTERNATIONAL GAMES SYSTEM CO., LTD., New Taipei City (TW)

(21) Appl. No.: 13/940,393

(22) Filed: Jul. 12, 2013

(51) Int. Cl. G06F 21/57

(52) U.S. Cl. CPC G06F 21/575
USPC 713/2

(57) ABSTRACT

The present invention provides a verification method for system execution environment. According to the present invention, at least an algorithm is used for operating a basic input/output system (BIOS) and loaded program check information, a first characteristic code and operation system check information, a second characteristic code and file system check information, a third characteristic system library check information, and a fourth characteristic code and application program check information for acquiring the first to fifth characteristic codes. After verifying the first to fourth characteristic codes, unlocking a storage, loading an operational system, loading a file system, and loading a system library are executed. After all characteristic codes have passed verification, the application program is executed. Thereby, whether the execution environment for the system or program is reliable can be confirmed.

### FIELD OF THE INVENTION

The present invention relates generally to a verification method, and particularly to a verification method for system execution environment, which uses an algorithm to calculate the data including hardware information and generate a characteristic code. Then, according to the characteristic code, the procedure from unlocking the storage to executing application programs after booting is performed for verifying that the system or program execution environment is a reliable system execution environment.

### BACKGROUND OF THE INVENTION

In recent years, as information technology develops and the information capability of general users enhances, the difficulty of duplicating and porting operational systems and application programs decreases year by year; engineers own the techniques of porting an operational system to other hardware or an application program to another operational system. Although the applications of operational systems and application programs become more widespread and convenient, the unit developing the operational systems and application programs is hard to control unauthorized usage by others. Accordingly, when the system and programs are loaded or executed, hardware verification is performed for ensuring that the system and program execution environment is a reliable system environment. Thereby, the loss due to infringement of the rights of the unit developing the operational systems and programs by others can be reduced.

Accordingly, the present invention provides a verification method for system execution environment. After a host is booted, verification of hardware information is performed before unlocking a storage, loading an operational system, loading a file system, loading a system library, and executing an application program for ensuring that the current system environment is a reliable execution environment. Before unlocking the storage, the operational unit or a remote host operates a basic input/output system (BIOS) data and loaded program check information for producing a first characteristic code. Then after the operational unit or the remote host verifies the first characteristic code according a first verification code, the operational unit unlocks the storage. Before loading the operational system, the operational unit or the remote host operates the first characteristic code and operational system check information for producing a second characteristic code. Then after the operational unit or the remote host verifies the second characteristic code according a second verification code, the operational unit loads the operational system. Before loading the file system, the operational unit or the remote host operates the second characteristic code and file system check information for producing a third characteristic code. Then after the operational unit or the remote host verifies the third characteristic code according a third verification code, the operational unit loads the file system. Before loading the system library, the operational unit or the remote host operates the third characteristic code and system library check information for producing a fourth characteristic code. Then after the operational unit or the remote host verifies the fourth characteristic code according a fourth verification code, the operational unit loads the system library. Before executing the application program, the operational unit or the remote host operates the fourth characteristic code and application program check information for producing a fifth characteristic code. Then after the operational unit or the remote host verifies the fifth characteristic code according a fifth verification code, the operational unit or the remote host confirms that all characteristic codes have passed verification; then the operational unit executes the application program. If any of previous procedures fails in verification, the operational unit cannot execute the application program normally. By this method, whether the execution environment is a reliable system environment can be confirmed.

### SUMMARY

An objective of the present invention is to provide a verification method for system execution environment. Before unlocking a storage, verification check is performed for ensuring that the execution environment is a reliable system environment.

Another objective of the present invention is to provide a verification method for system execution environment. Before loading an operational system, verification check is performed for ensuring that the execution environment is a reliable system environment.

Still another objective of the present invention is to provide a verification method for system execution environment. Before loading a file system, verification check is performed for ensuring that the execution environment is a reliable system environment.

A further objective of the present invention is to provide a verification method for system execution environment. Before loading a system library, verification check is performed for ensuring that the execution environment is a reliable system environment.

A still further objective of the present invention is to provide a verification method for system execution environment. Before executing an application program, verification check is performed for ensuring that the execution environment is a reliable system environment.

For achieving the objectives described above, the present invention provides a verification method for system execution environment, which is executed after an operational unit unlocks a storage, loads an operational system, and produces a second characteristic code sequentially after booting. The verification method for system execution environment comprises the following steps. The operational unit loads a file system after a third characteristic code is produces according to a second characteristic and the third characteristic code is verified according to a third verification code. The operational unit loads a system library after a fourth characteristic code is produces according to the third characteristic and the fourth characteristic code is verified according to a fourth verification code. Then, a fifth characteristic code is produces according to the fourth characteristic and the fifth characteristic code is verified according to a fifth verification code. After all characteristic codes have passed verification, the operational unit executes an application program.

The step “an operational unit unlocks a storage, loads an operational system, and produces a second characteristic code sequentially after booting” described above can further comprises steps of the operational unit extracting BIOS data after booting; the operational unit unlocking a storage after the operational unit produces a first characteristic code according to the BIOS data and verifies the first characteristic code according to a first verification code; and the operational unit loading an operational system after the operational unit produces a second characteristic code according to the first characteristic code and verifies the second characteristic code according to a second verification code. The BIOD data include hardware information and BIOS information. The hardware information and the BIOS information is the information given by inspecting at least a piece of hardware of a computer system.

The first characteristic code, the second characteristic code, the third characteristic code, the fourth characteristic code, and the fifth characteristic code described above are produced according to at least an algorithm.

Before unlocking the storage, integrity check for a loaded program can be included for producing loaded program check information and checking the integrity of the loaded program. The first characteristic code can be produced according to the BIOS data and the loaded program check information. Before loading the operational system, integrity check for the operational system can be included for producing operational system check information and checking the integrity of the operational system. The second characteristic code can be produced according to the first characteristic code and the operational system check information. Before loading the file system, integrity check for the file system can be included for producing file system check information and checking the integrity of the file system. The third characteristic code can be produced according to the second characteristic code and the file system check information. Before loading the system library, integrity check for the file system can be included for producing system library check information and checking the integrity of the system library. The fourth characteristic code can be produced according to the third characteristic code and the system library check information. Before loading the application program, integrity check for the application program can be included for producing application program check information and checking the integrity of the application program. The fifth characteristic code can be produced according to the fourth characteristic code and the application program check information. By checking the loaded program, the operational system, the file system, the system library, and the application program, it is ensured that the system or the program is executed on a trusted platform.

The first characteristic code, the second characteristic code, the third characteristic code, the fourth characteristic code, and the fifth characteristic code can be produced by the operational unit or a remote host connected with the host, respectively. Besides, verification can be performed by the operational unit or the remote host, respectively.

The first characteristic code, the second characteristic code, the third characteristic code, the fourth characteristic code, and the fifth characteristic code can include a program code, for example, a function. The function can be called and executed while unlocking the storage, loading the operational system, loading the file system, loading the system library, and executing the application program. Alternatively, the function is not involved in the process of unlocking the storage, loading the operational system, loading the file system, loading the system library, and executing the application program. Nonetheless, when the first characteristic code, the second characteristic code, the third characteristic code, the fourth characteristic code, and the fifth characteristic code have errors, the process of unlocking the storage, loading the operational system, loading the file system, loading the system library, and executing the application program cannot be performed normally.

Moreover, the first characteristic code, the second characteristic code, the third characteristic code, the fourth characteristic code, and the fifth characteristic code can compare with a first verification code, a second verification code, a third verification code, a fourth verification code, and a fifth verification code, respectively. If the comparison results are identical, it is correct. Then the steps of unlocking the storage, loading the operational system, loading the file system, loading the system library, and executing the application program can be executed. The first verification code can be acquired from a memory unit or a remote host and compared with the first characteristic code. When the first characteristic code is identical to the first verification code, the operational unit unlocks the storage. The second verification code can be acquired from the memory unit or the remote host and compared with the second characteristic code. When the second characteristic code is identical to the second verification code, the operational unit loads the operational system. The third verification code can be acquired from the memory unit or the remote host and compared with the third characteristic code. When the third characteristic code is identical to the third verification code, the operational unit loads the file system. The fourth verification code can be acquired from the memory unit or the remote host and compared with the fourth characteristic code. When the fourth characteristic code is identical to the fourth verification code, the operational unit loads the system library. The fifth verification code can be acquired from the memory unit or the remote host and compared with the fifth characteristic code. When the fifth characteristic code is identical to the fifth verification code, the operational unit loads the application program.

Furthermore, any two of the first verification code, the second verification code, the third verification code, the fourth verification code, and the fifth verification code can have identical values.

### BRIEF DESCRIPTION OF THE DRAWINGS

FIG. 1 shows an overall flowchart according to the first embodiment of the present invention;

FIG. 2A shows a flowchart from booting to loading operational system according to the first embodiment of the present invention; and

FIG. 2B shows a flowchart from loading operational system to executing application program according to the first embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The verification method for system execution environment according to the present invention is characterized in the following. Before unlocking a storage, loading an operational system, loading a file system, loading a system library, and executing an application program, verification checks are performed. Characteristic codes corresponding to respective verification checks are produced through at least an algorithm. Then verification can be performed according to the respectively characteristic codes for unlocking the storage, loading the operational system, loading the file system, and loading the system library sequentially. After all characteristic codes have passed verification, the application program can be executed normally. Thereby, whether the system environment is a reliable platform system can be confirmed.

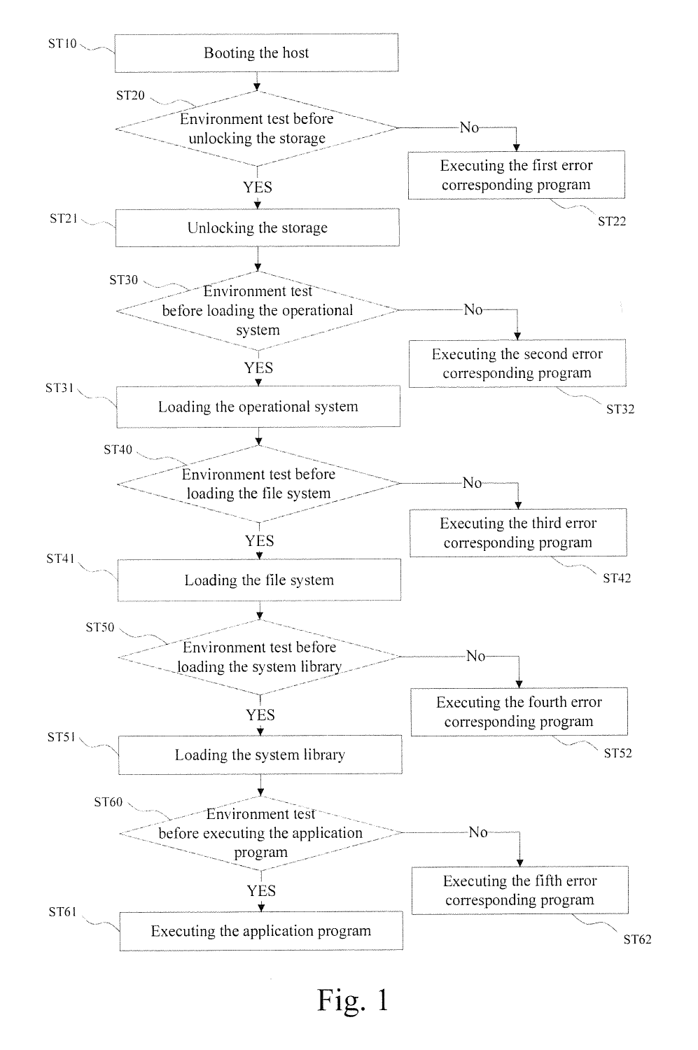

First, FIG. 1 shows an overall flowchart according to the first embodiment of the present invention. As shown in the figure, the present invention provides a verification method for system execution environment, which comprises steps of:
Step ST10: Booting the host;
Step ST20: Environment test before unlocking the storage;
Step ST21: Unlocking the storage;
Step ST22: Executing the first error corresponding program;
Step ST30: Environment test before loading the operational system;
Step ST31: Loading the operational system;
Step ST32: Executing the second error corresponding program;
Step ST40: Environment test before loading the file system;
Step ST41: Loading the file system;
Step ST42: Executing the third error corresponding program;
Step ST50: Environment test before loading the system library;
Step ST51: Loading the system library;
Step ST52: Executing the fourth error corresponding program;
Step ST60: Environment test before executing the application program;
Step ST61: Executing the application program; and
Step ST62: Executing the fifth error corresponding program.

In the step ST10, a user boots a host adopting the testing method according to the present invention and loads a BIOS. In the step ST20, an environment test before unlocking storage is performed. If the environment test before unlocking storage is passed, the step ST 21 is performed for unlocking a storage and loading a program. If not, the step ST22 is performed for executing a first error corresponding program. After the step ST21, the step ST30 is executed for performing an environment test before loading operational system. If the environment test before loading operational system is passed, the step ST31 is performed for loading an operational system. If not, the step ST32 is performed for executing a second error corresponding program. After the step ST31, the step ST40 is executed for performing an environment test before loading file system. If the environment test before loading file system is passed, the step ST41 is performed for loading a file system and completing initialization and booting of the operational system. If not, the step ST42 is performed for executing a third error corresponding program. After the step ST41, the step ST50 is executed for performing an environment test before loading system library. If the environment test before loading system library is passed, the step ST51 is performed for loading the system library and staring an application program. If not, the step ST52 is performed for executing a fourth error corresponding program. After the step ST51, the step ST60 is executed automatically or according to the operations of the user while executing the application program for performing an environment test before executing application program. If the environment test before executing application program is passed, the step ST61 is performed for executing the application program. If not, the step ST62 is performed for executing a fifth error corresponding program.

After the step ST22 is executed, unlocking the storage cannot be performed normally or the loaded program cannot be loaded correctly. Execute the first error corresponding program to reboot the host automatically, shutdown the host automatically, or execute other first error corresponding step, such as performing the step S21. But finally, the step ST61 will not be executed and the application program cannot be executed normally. After the step ST32 is executed, loading the operational system cannot be performed normally. Execute the second error corresponding program to reboot the host automatically, shutdown the host automatically, return to the step ST30 automatically for re-test, wait for the user to reboot the host manually, to shutdown the host manually, or to return to the step ST30 manually for re-test, or execute other second error corresponding step, such as performing the step S31. But finally, the step ST61 will not be executed and the application program cannot be executed normally. After the step ST42 is executed, loading the file system cannot be performed normally. Execute the third error corresponding program to reboot the host automatically, shutdown the host automatically, return to the step ST40 automatically for re-test, wait for the user to reboot the host manually, to shutdown the host manually, or to return to the step ST40 manually for re-test, or execute other third error corresponding step, such as performing the step ST41. But finally, the step ST61 will not be executed and the application program cannot be executed normally. After the step ST52 is executed, loading the system library cannot be performed normally. Execute the fourth error corresponding program to shutdown or reboot the application program automatically, wait for the user to shutdown or reboot the application program manually, or execute other fourth error corresponding step, such as performing the step S51. But finally, the step ST61 will not be executed and the application program cannot be executed normally. After the step ST62 is executed, executing the application program cannot be performed normally. Execute the fifth error corresponding program to shutdown or reboot the application program automatically, wait for the user to shutdown or reboot the application program manually, or execute other fifth error corresponding step.

Accordingly, by implementing the steps ST10, ST20, ST21 or ST22, ST30, ST31 or ST32, ST40, ST41 or ST42, ST50, ST51 or ST52, ST60, ST61 or ST62, the system environment can be tested before unlocking a storage, loading an operational system, loading a file system, loading a system library, and executing an application program for confirming if the system environment during booting, entering the operational system, and executing the application program is reliable. Then the application program is executed normally only when the system environment is reliable.

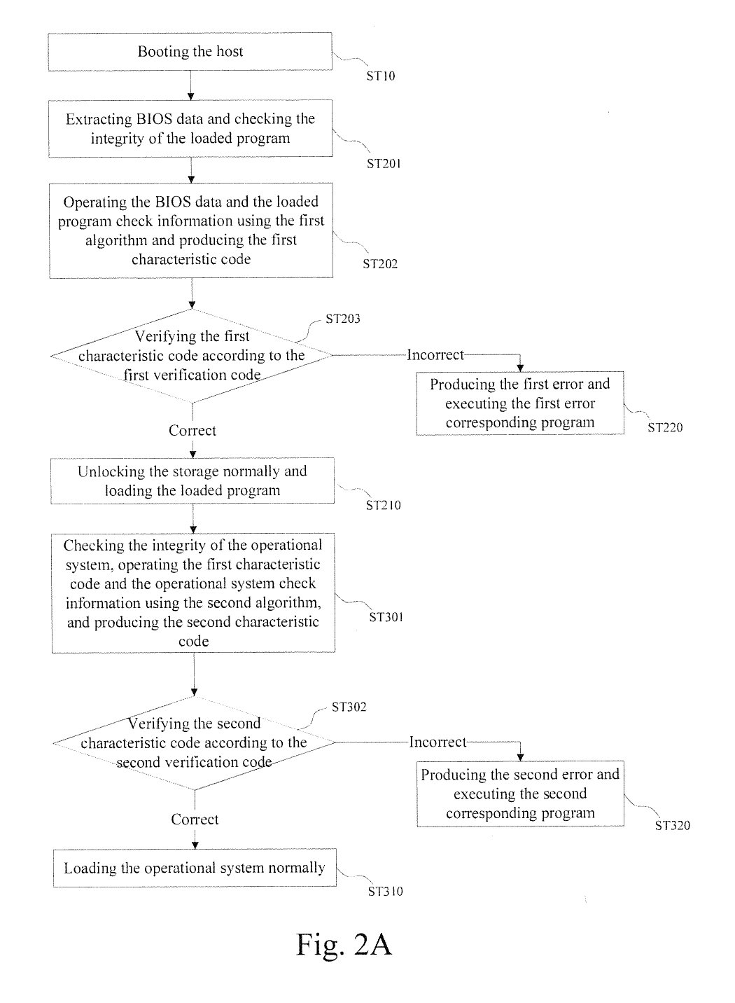

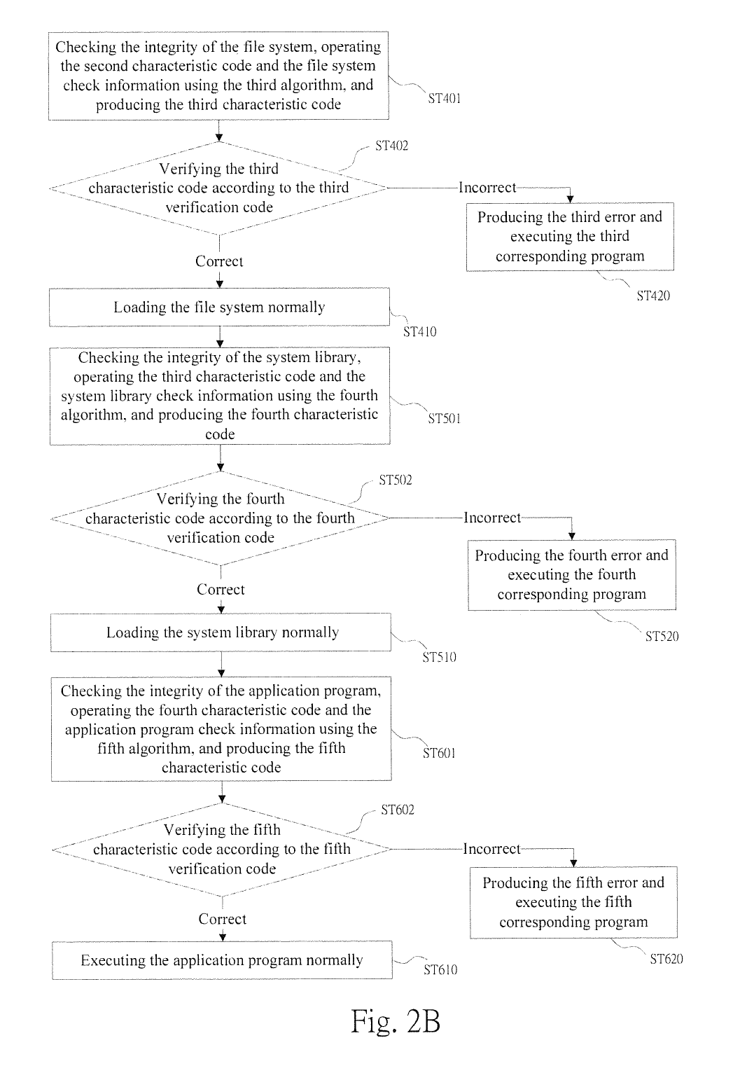

FIG. 2A shows a flowchart from booting to loading operational system according to the first embodiment of the present invention; and FIG. 2B shows a flowchart from loading operational system to executing application program according to the first embodiment of the present invention. As shown in FIG. 2A, the procedure from booting to loading operational system according to the present invention comprises:
Step ST10: Booting the host;
Step ST201: Extracting BIOS data and checking the integrity of the loaded program;
Step ST202: Operating the BIOS data and the loaded program check information using the first algorithm and producing the first characteristic code;
Step ST203: Verifying the first characteristic code according to the first verification code;
Step ST210: Unlocking the storage normally and loading the loaded program;
Step ST220: Producing the first error and executing the first error corresponding program;
Step ST301: Checking the integrity of the operational system, operating the first characteristic code and the operational system check information using the second algorithm, and producing the second characteristic code;
Step ST302: Verifying the second characteristic code according to the second verification code;
Step ST310: Loading the operational system normally; and
Step ST320: Producing the second error and executing the second corresponding program.

In the step ST10, a user boots a host adopting the verification method according to the present invention. After booting, the host loads a BIOS automatically. The BIOS performs a power-on self-test (POST) verification for at least a piece of hardware for generating BIOS data, which include hardware information and BIOS information. In the step ST201, an operational unit extracts the hardware information and the BIOS information for producing loaded program check information and checking the integrity of a loaded program. Thereby, in the step ST202, the operational unit or a remote host connected with the host can produce a first characteristic code by means of the operations of the BIOS data and the loaded program check information using a first algorithm. In the step ST203, the operational unit or the remote host verifies the first characteristic code according to a first verification code acquired from a memory unit or the remote host for completing the environment test before unlocking the storage (the step S20 described above). If the first characteristic code is correct, for example, when the first characteristic code and the first verification code are identical, it is judged that the first characteristic code is correct. Then the step ST210 is executed, in which step the operational unit unlocks the storage normally and loads the loaded program. If the first characteristic code is incorrect and the verification is not passed, the step S220 is executed and a first error is produced; the operational unit executes a first error corresponding program. After the step ST210, the step ST301 is executed, in which step the operational unit produces operational system check information for checking the integrity of an operational system. In addition, the operational unit or the remote host produces a second characteristic code by means of the operations of the first characteristic code and the operational system check information using a second algorithm. In the step ST302, the operational unit or the remote host verifies the second characteristic code according to a second verification code acquired from the memory unit or the remote host for completing the environment test before loading the operational system (the step ST30 described above). If the second characteristic code is correct, for example, when the second characteristic code and the second verification code are identical, it is judged that the second characteristic code is correct. Then the step ST310 is executed, in which step the operational unit loads the operational system normally. If the second characteristic code is incorrect and the verification is not passed, the step ST320 is executed and a second error is produced; the operational unit executes a second error corresponding program.

As described above, after the step ST220 is executed, unlocking the storage cannot be performed normally or the loaded program cannot be loaded correctly. Execute the first error corresponding program to reboot the host automatically, shutdown the host automatically, or execute other first error corresponding step. After the step ST320 is executed, loading the operational system cannot be performed normally. Execute the second error corresponding program to reboot the host automatically, shutdown the host automatically, return to the step ST30 automatically for re-test, wait for the user to reboot the host manually, to shutdown the host manually, or to return to the step ST301 manually for re-test, or execute other second error corresponding step.

Accordingly, by implementing the steps ST10, ST201, ST202, ST203, ST210 or ST220, ST301, ST302, ST310 or ST320, after the host is booted and before unlocking a storage and loading an operational system, respectively, the characteristic codes can be produced by operations according to the hardware information using algorithms. Besides, after verifying the characteristic codes, the steps of unlocking the storage and loading the operational system are executed. The steps of unlocking the storage and loading the operational system and the subsequent steps cannot be executed normally unless the characteristic codes are correct. Thereby, system environment can verified for confirming if the system environment from booting to starting the operational system is reliable.

As shown in FIG. 2B, the procedure from loading operational system to executing application program according to the present invention comprises:
Step ST401: Checking the integrity of the file system, operating the second characteristic code and the file system check information using the third algorithm, and producing the third characteristic code;
Step ST402: Verifying the third characteristic code according to the third verification code;
Step ST410: Loading the file system normally;
Step ST420: Producing the third error and executing the third corresponding program;
Step ST501: Checking the integrity of the system library, operating the third characteristic code and the system library check information using the fourth algorithm, and producing the fourth characteristic code;
Step ST502: Verifying the fourth characteristic code according to the fourth verification code;
Step ST510: Loading the system library normally;
Step ST520: Producing the fourth error and executing the fourth corresponding program;
Step ST601: Checking the integrity of the application program, operating the fourth characteristic code and the application program check information using the fifth algorithm, and producing the fifth characteristic code;
Step ST602: Verifying the fifth characteristic code according to the fifth verification code;
Step ST610: Executing the application program normally; and
Step ST620: Producing the fifth error and executing the fifth corresponding program.

After the step ST310 described above, the step ST401 is executed, in which step the operational unit produces file system check information for checking the integrity of a file system. In addition, the operational unit or the remote host produces a third characteristic code by means of the operations of the second characteristic code and the file system check information using a third algorithm. In the step ST402, the operational unit or the remote host verifies the third characteristic code according to a third verification code acquired from the memory unit or the remote host for completing the environment test before loading the file system (the step ST40 described above). If the third characteristic code is correct, for example, when the third characteristic code and the third verification code are identical, it is judged that the third characteristic code is correct. Then the step ST410 is executed, in which step the operational unit loads the file system normally. If the third characteristic code is incorrect and the verification is not passed, the step ST42 is executed and a third error is produced; the operational unit executes a third error corresponding program. After the step ST410 described above, the step ST501 is executed, in which step the operational unit produces system library check information for checking the integrity of a system library. In addition, the operational unit or the remote host produces a fourth characteristic code by means of the operations of the third characteristic code and the system library check information using a fourth algorithm. In the step ST502, the operational unit or the remote host verifies the fourth characteristic code according to a fourth verification code acquired from the memory unit or the remote host for completing the environment test before loading the system library (the step ST50 described above). If the fourth characteristic code is correct, for example, when the fourth characteristic code and the fourth verification code are identical, it is judged that the fourth characteristic code is correct. Then the step ST51 is executed, in which step the operational unit loads the system library normally. If the fourth characteristic code is incorrect and the verification is not passed, the step ST52 is executed and a fourth error is produced; the operational unit executes a fourth error corresponding program. After the step ST510 described above, the step ST601 is executed automatically or when the user executes the functional operations of the application program. In the step ST601, the operational unit produces application program check information for checking the integrity of the application program. In addition, the operational unit or the remote host produces a fifth characteristic code by means of the operations of the fourth characteristic code and the application program check information using a fifth algorithm. In the step ST602, the operational unit or the remote host verifies the fifth characteristic code according to a fifth verification code acquired from the memory unit or the remote host for completing the environment test before executing the application program (the step ST60 described above). If the fifth characteristic code is correct, for example, when the fifth characteristic code and the fifth verification code are identical, it is judged that the fourth characteristic code is correct. Then the step ST61 is executed, in which step the application program is executed normally. If the fifth characteristic code is incorrect, the step ST62 is executed and a fifth error is produced; the operational unit executes a fifth error corresponding program.

As described above, after the step ST420 is executed, loading the file system cannot be performed normally. Execute the third error corresponding program to reboot the host automatically, shutdown the host automatically, return to the step ST402 automatically for re-test, wait for the user to reboot the host manually, to shutdown the host manually, or to return to the step ST402 manually for re-test, or execute other third error corresponding step. After the step ST520 is executed, loading the application program cannot be performed normally. Execute the fourth error corresponding program to shutdown or restart the application program automatically, wait for the user to shutdown or restart the application program manually, or execute other fourth error corresponding step. After the step ST620 is executed, executing the application program cannot be performed normally. Execute the fifth error corresponding program to shutdown or restart the application program automatically, wait for the user to shutdown or restart the application program manually, or execute other fifth error corresponding step.

Accordingly, by implementing the steps ST401, ST402, ST410 or ST420, ST501, ST502, ST51 or ST520, ST601, ST602, ST610 or ST620, after loading the operational system, from loading the file system to executing the application program, the characteristic codes can be produced by operations according to the hardware information using algorithms. Besides, after verifying the characteristic codes, the steps of loading the file system, loading the system library, and executing the application program are executed. The steps of loading the file system, loading the system library, and executing the application program cannot be executed normally unless the characteristic codes are correct. Thereby, system environment can verified for confirming if, after loading the operational system, the execution environment from loading the file system to executing the application program is reliable.

To sum up, the present invention provides a verification method for system execution environment. Respective algorithms are used for operating at least a piece of hardware information for acquiring respectively characteristic codes. The respectively characteristic codes are compared with respective verification codes for performing verification unlocking a storage, loading an operational system, loading a file system, loading a system library, and executing the application program. Thereby, whether the execution environment is a reliable system environment can be confirmed. The plurality of algorithms can be identical; the plurality of verification codes can have identical values as well. In addition, the first characteristic code, the second characteristic code, the third characteristic code, the fourth characteristic code, and the fifth characteristic code can be a segment of code such as a callable function. The function can be called and executed while unlocking the storage, loading the operational system, loading the file system, loading the system library, or executing the application program. Alternatively, the function can be compared with the first characteristic code, the second characteristic code, the third characteristic code, the fourth characteristic code, and the fifth characteristic code but not participating directly the process of unlocking the storage, loading the operational system, loading the file system, loading the system library, or executing the application program. Besides, if the characteristic codes are incorrect, the subsequent steps cannot be executed correctly. Thereby, whether the execution environment is a reliable environment can be confirmed.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A verification method for system execution environment, executed after booting a host, an operation unit unlocking a storage, loading an operational system, and producing a second characteristic code, and comprising steps of:
producing a third characteristic code according to said second characteristic code, and said operational unit loading a file system after verifying said third characteristic code according a third verification code;
producing a fourth characteristic code according to said third characteristic code, and said operational unit loading a system library after verifying said fourth characteristic code according a fourth verification code;
producing a fifth characteristic code according to said fourth characteristic code, and verifying said fifth characteristic code according a fifth verification code; and
confirming that all verification codes are identical to all characteristic codes, respectively, and said operational unit executing an application program;
where said third characteristic code, said fourth characteristic code, and said fifth characteristic code are produced according to at least an algorithm.

2. The verification method for system execution environment according to claim 1, wherein said third characteristic code is produced according to said second characteristic code and file system check information.

3. The verification method for system execution environment according to claim 1, wherein said fourth characteristic code is produced according to said third characteristic code and system library check information.

4. The verification method for system execution environment according to claim 1, wherein said fifth characteristic code is produced according to said fourth characteristic code and application program check information.

5. The verification method for system execution environment according to claim 1, wherein said third characteristic code is produced by said operational unit or a remote host and verified by said operational unit and said remote host according to said third verification code.

6. The verification method for system execution environment according to claim 1, wherein said fourth characteristic code is produced by said operational unit or a remote host and verified by said operational unit and said remote host according to said fourth verification code.

7. The verification method for system execution environment according to claim 1, wherein said fifth characteristic code is produced by said operational unit or a remote host and verified by said operational unit and said remote host according to said fifth verification code.

8. The verification method for system execution environment according to claim 1, wherein said third verification code is acquired by a memory unit or a remote host, and said operational unit or said remote host compares said third characteristic code with said third verification code.

9. The verification method for system execution environment according to claim 1, wherein said fourth verification code is acquired by a memory unit or a remote host, and said operational unit or said remote host compares said fourth characteristic code with said fourth verification code.

10. The verification method for system execution environment according to claim 1, wherein said fifth verification code is acquired by a memory unit or a remote host, and said operational unit or said remote host compares said fifth characteristic code with said fifth verification code.

11. The verification method for system execution environment according to claim 1, and before said steps, further comprising steps of:
said operational unit extracting basic input/output system data;
producing a first characteristic code according to said basic input/output system data, and after verifying said first characteristic code according a first verification code, said operational unit unlocking a storage; and
producing a second characteristic code according to said first characteristic code, and after verifying said second characteristic code according a second verification code, said operational unit loading an operational system;
where said first characteristic code and said second characteristic code are produced according to at least an algorithm.

12. The verification method for system execution environment according to claim 11, wherein said basic input/output system data include hardware information and basic input/output system information.

13. The verification method for system execution environment according to claim 11, wherein said first characteristic code is produced according to said basic input/output system data and loaded program check information.

14. The verification method for system execution environment according to claim 11, wherein said second characteristic code is produced according to said second characteristic code and operational system check information.

15. The verification method for system execution environment according to claim 11, wherein said first characteristic code is produced by said operational unit or a remote host, and said operational unit or said remote host verifies according to said first verification code.

16. The verification method for system execution environment according to claim 11, wherein said second characteristic code is produced by said operational unit or a remote host, and said operational unit or said remote host verifies according to said second verification code.

17. The verification method for system execution environment according to claim 11, wherein said first characteristic code is acquired from a memory unit or a remote host, and said operational unit or said remote host compares said first characteristic code with said first verification code.

18. The verification method for system execution environment according to claim 11, wherein said second characteristic code is acquired from a memory unit or a remote host, and said operational unit or said remote host compares said second characteristic code with said second verification code.

19. The verification method for system execution environment according to claim 1, wherein after said operational unit verifies said fifth characteristic code according to said fifth verification code, if at least a acquired verification code is not identical to at least a corresponding characteristic code, said operational unit stops operating.
